(19) United States
(12) Patent Application Publication
(10) Pub. No.: US 2022/0186939 A1
(43) Pub. Date: Jun. 16, 2022

(54) UNIVERSAL DOOR FRAME FOR COOKING APPLIANCE

(71) Applicants: BSH Home Appliances Corporation, Irvine, CA (US); BSH Hausgeräte GmbH, Munich (DE)

(72) Inventors: Brendon Keeler, New Bern, NC (US); Steven Langenscheidt, Arapahoe, NC (US)

(21) Appl. No.: 17/117,168

(22) Filed: Dec. 10, 2020

(51) Int. Cl. F24C 15/04; F24C 15/00; F16B 2/20

(52) U.S. Cl. CPC F24C 15/04; F16B 2/20; F24C 15/006

(57) ABSTRACT

A universal door frame is configured to aid in assembling a door for use with a cooking appliance. The door frame includes four corner components and variable-length rails to be connected therebetween. The corner components include hinge receivers and mounting brackets for panels of the door. In some examples, one or more of the rails have a vented construction for enabling air-cooling of the door. The door frame optionally includes vent covers for covering the vented rails.

### FIELD

This disclosure relates to systems and methods for doors. More specifically, the disclosed embodiments relate to doors and door frames for use with cooking appliances.

### INTRODUCTION

Cooking appliances such as gas or electric ovens are constructed in many different sizes, including numerous heights and widths. Due to the wide range of sizes, there are an equally wide range of individually sized doors and door frames.

### SUMMARY

A solution for producing a number of differently sized door frames would simplify the construction and assembly of cooking appliances and decrease the cost of cooking appliances passed on to consumers. The present disclosure provides systems, apparatuses, and methods relating to adjustable door frames for use in assembling and/or manufacturing home appliances.

In some embodiments, a door for use with a cooking appliance includes: a door frame including four corner components, each corner component having an opening configured to receive an end portion of a respective side rail; four side rails, each side rail coupled to two of the four corner components, wherein at least one of the side rails is configured to be insertable to different depths within the openings of the respective corner components.

In some embodiments, a cooking appliance includes: a housing defining an oven cavity therein; and a door configured to selectively close the oven cavity, the door comprising: a door frame including four corner components, each corner component having an opening configured to receive an end portion of a respective side rail; four side rails, each side rail coupled to two of the four corner components, wherein at least one of the side rails is configured to be insertable to different depths within the openings of the respective corner components.

In some embodiments, a method of manufacturing a cooking appliance includes: coupling a first rail to a first and a second corner component using first telescoping connections; coupling a second rail to a third and a fourth corner component using second telescoping connections; adjusting an effective length of the combined first rail, first corner component, and second corner component by changing an insertion depth of one of the first telescoping connections; adjusting an effective length of the combined second rail, third corner component, and fourth corner component by changing an insertion depth of one of the second telescoping connections; and coupling a first vented rail to the first and third corner components, the first vented rail including at least one aperture configured to allow air to pass therethrough.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a front elevation view of an illustrative cooking appliance in accordance with aspects of the present disclosure.

FIG. 2 is an isometric view of a universal door frame for use with the cooking appliance of FIG. 1 having a first set of height and width dimensions.

FIG. 3 is an isometric view of the universal door frame of FIG. 2 having a second set of height and width dimensions.

FIG. 4 is a front view of the universal door frame of FIG. 2.

FIG. 5 is a top view of the universal door frame of FIG. 2.

FIG. 6 is a side view of the universal door frame of FIG. 2.

FIG. 7 depicts a corner component of the universal door frame of FIG. 2.

FIG. 8 depicts a side rail of the universal door frame of FIG. 2.

FIG. 9 depicts a vented rail of the universal door frame of FIG. 2.

FIG. 10 is an isometric view of an assembled door including the universal door frame of FIG. 2 and a vent cover.

FIG. 11 is a schematic diagram depicting steps of an illustrative method of assembling a door for use with the appliance of FIG. 1.

### DETAILED DESCRIPTION

Various aspects and examples of a universal door frame are described below and illustrated in the associated drawings. Unless otherwise specified, a door frame in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Coupled” means connected, either permanently or releasably, whether directly or indirectly through intervening components.

“Resilient” describes a material or structure configured to respond to normal operating loads (e.g., when compressed) by deforming elastically and returning to an original shape or position when unloaded.

“Rigid” describes a material or structure configured to be stiff, non-deformable, or substantially lacking in flexibility under normal operating conditions.

“Elastic” describes a material or structure configured to spontaneously resume its former shape after being stretched or expanded.

Directional terms such as “up,” “down,” “vertical,” “horizontal,” and the like should be understood in the context of the particular object in question. For example, an object may be oriented around defined X, Y, and Z axes. In those examples, the X-Y plane will define horizontal, with up being defined as the positive Z direction and down being defined as the negative Z direction.

“Providing,” in the context of a method, may include receiving, obtaining, purchasing, manufacturing, generating, processing, preprocessing, and/or the like, such that the object or material provided is in a state and configuration for other steps to be carried out.

### Overview

In general, a cooking appliance door in accordance with the present disclosure includes a universal door frame configured to conform adjustably to a desired door size, e.g., a door sized to appropriately open and close a cavity of the cooking appliance. The door frame includes corner components coupled to connecting rails. This configuration greatly reduces the cost of construction by facilitating the construction of door frames assembled from the same or similar components in a wide range of sizes. In some examples, the corner components and rails utilize a snap-together (e.g., push button) style coupling, such that a door frame may be quickly assembled from pre-constructed parts.

The corner components of the universal door frame may comprise a temperature resistant plastic (e.g., a fluoropolymer, heat resistant vinyl, etc.), a heat resistant composite, and/or a cast or extruded metal (e.g., aluminum, steel, etc.). Some (e.g., two) of the corner components may include a connecting interface for use with a hinge. For example, the bottom or side corner components may each include a receiver (AKA a receiving compartment) for a knife hinge, or another hinge interface.

The corner components may further include a mounting surface for a front and/or back panel of the door. For example, each corner component may include a bracket (e.g., a triangular corner bracket) configured to receive a respective corner of the front and/or back panel. In some examples, one of the front or back panels are received by the brackets and the other is coupled directly to another surface or feature of the corner components, for example using an adhesive.

The connecting rails may comprise a cast metal, folded sheet metal, extruded metal (e.g., extruded aluminum), a temperature resistant plastic, and/or the like. In some examples, the rails are pre-built to different varying lengths. In some examples, the rails are constructed to be a pre-specified length corresponding to a desired length or width of the door frame. In some examples, the rails are configured to be inserted into the corner components at various telescoping depths, thereby allowing a multitude of variable lengths or widths of the door frame. For example, to create a door frame that is wider than it is tall, the side rails may be inserted into the corner pieces at deeper depths than the top and bottom rails.

The connecting rails may be coupled to the corner components by a variety of methods. For example, the connection rails may be coupled to the corner components through the use of a removable fastener (e.g., a screw or bolt). The removable fastener may be configured to pass through both a connecting rail and a corresponding corner component. In some examples, the connecting rails have a plurality of apertures distributed at regular intervals, such that the rail may be inserted into a corresponding corner component and the removable fastener may be placed through any one of the plurality of apertures, thereby defining a length or width of the door frame. In some examples, the rails are configured to be non-removably coupled to the corner components, for example, by an adhesive, welding, or other non-removable means. In some examples, the rails and corner components may include complementary, reusable fasteners such as a spring-loaded push-button fastener.

In some embodiments, one or more of the rails (e.g., the top and bottom rails) comprise a vented construction. The rails comprising a vented construction may be referred to as vented rails. The vented rails include one or more openings or apertures configured to allow air to pass through the rails. For example, the vented rails may be coupled to an air cooling system such that, when the door is closed, the vented rails pass air from the air cooling system to a space formed between the front and back panels of the door, thereby cooling the door.

In some embodiments, the cooking appliance door includes one or more vent covers configured to cover one or more vented rails. For example, the top and bottom rails of the door frame may comprise vented rails and, accordingly, the top and bottom portions of the door may comprise vent covers fully or partially covering the vented rails.

### Examples, Components, and Alternatives

The following sections describe selected aspects of illustrative universal door frames as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Home Cooking Appliance

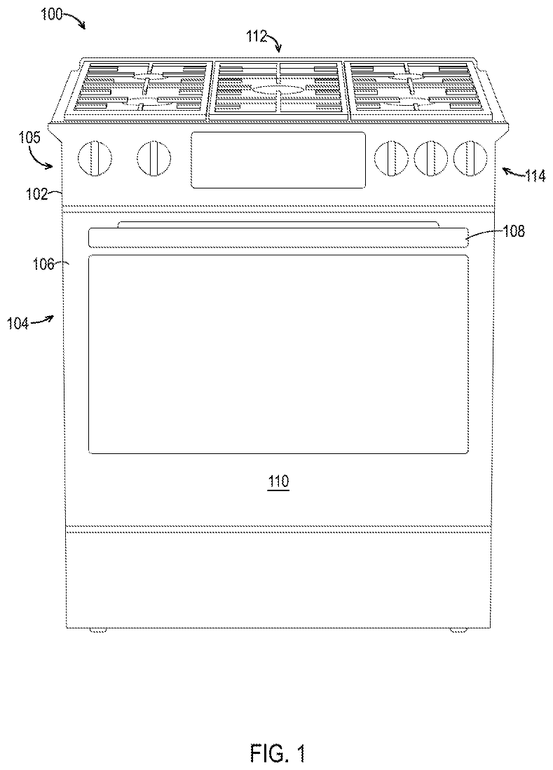

As shown in FIG. 1, this section describes an illustrative cooking appliance 100 (e.g., gas oven, electric oven, etc.). Cooking appliance 100 is an example of the cooking appliance described above.

Cooking appliance 100 includes an appliance housing 102 and an appliance cavity 104 (e.g., oven cavity) internal to the appliance housing. The housing defines an upper compartment 105 disposed above the oven cavity, which may be configured to contain circuitry and/or piping associated with cooking functions. In some examples, the housing defines side and rear compartments disposed outside the oven cavity, the compartments configured to provide an insulating barrier between the oven cavity and the housing. The upper compartment and the insulating side and rear compartments may be separated by interior walls of housing 102.

Housing 102 includes an opening in a front surface of the housing to allow access to cavity 104. Cooking appliance 100 additionally includes a door 106, pivotably coupled to the front surface of the housing, such that the door is configured to selectively open and close the opening of the cavity. Door 106 may include a handle 108 disposed on a front surface (AKA panel) 110.

Gas cooking appliance 100 includes one or more suitable heating elements (e.g., gas burner, electric heating element, etc.) configured to heat appliance cavity 104 to a selected temperature. The appliance may further include additional heating elements 112 (e.g., a gas range, electric range, inductive range, etc.) disposed on, in, or adjacent a top surface of housing 102.

Temperature and/or heat intensity of appliance cavity 104 and heating elements 112 may be adjusted via a human-machine interface (HMI), e.g., in the form of one or more controls 114 disposed on a front or top surface of the cooking appliance. In some embodiments, cooking appliance 100 includes an electronic controller configured to adjust temperature of appliance cavity 104, as a result of predetermined values input by a user or calculated by the control system. In some embodiments, controls 114 include a plurality of adjustment knobs or dials. For example, a user may rotate one of the knobs to increase or decrease the heat intensity of a corresponding one or more heating elements.

### B. Illustrative Universal Door Frame

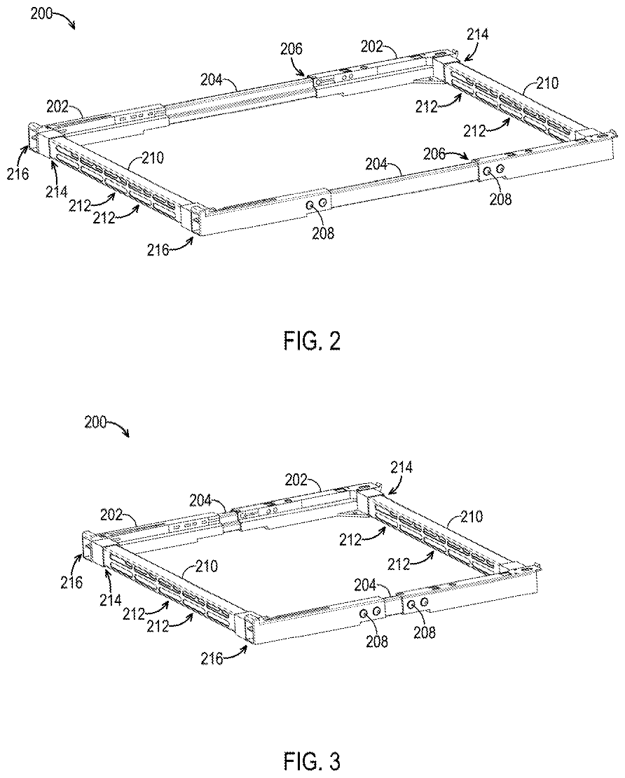

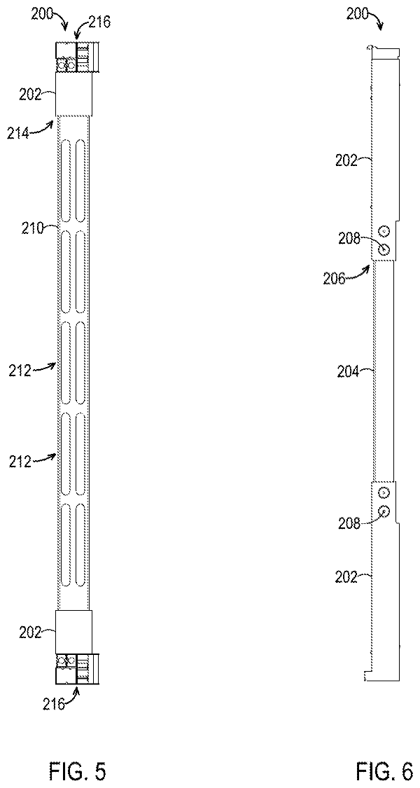

As shown in FIGS. 2-10, this section describes an illustrative universal door frame 200. Universal door frame 200 is configured to be utilized in the construction of a door for a cooking appliance, for example door 106 of cooking appliance 100 described above.

Universal door frame 200 includes a plurality of corner components 202. In the current example, door frame 200 includes four identical corner components, such that the door assembled on the frame has a generally rectangular shape. Corner components 202 may comprise a temperature resistant plastic (e.g., a fluoropolymer, heat resistant vinyl, etc.), a heat resistant composite, or a cast metal (e.g., aluminum, steel, etc.).

Door frame 200 includes rails 204 (see FIG. 8) configured to connect neighboring corner components 202. Rails 204 may comprise a cast metal, folded sheet metal, extruded metal (e.g., extruded aluminum), or a temperature resistant plastic. As shown in FIGS. 2 and 3, the utilization of corner components 202 and rails 204 enables door frame 200 to be assembled into various different lengths and widths from the same or similar components.

Each rail 204 is configured to be received by two corresponding corner components 202 at interface 206. Interface 206 has a complementary cross-sectional perimeter matching that of rails 204. For example, in the embodiment depicted in FIGS. 2-10, rails 204 have an L-shaped cross section and interface 206 has a complementary shape for receiving rails 204 therein. In some examples, the cross-sectional profile of rails 204 and interface 206 may be square, rectangular, U-shaped, I-shaped H-shaped, or another suitable shape.

Door frame 200 includes fasteners 208 configured to couple the corner components to the rails. In some examples, frame 200 includes two fasteners disposed proximate interface 206, though other configurations may be utilized (e.g., single fasteners, or three or more fasteners). In some examples, fasteners 208 are removable fasteners (e.g., screws, bolts, etc.) configured to pass through both corner components 202 and rails 204, thus securing them together. In some examples, fasteners 208 include releasable push buttons (e.g., spring-biased buttons) disposed on rails 204 and configured to pass through corresponding apertures in corner components 202. In some examples, fasteners include releasable push buttons disposed within corner components 202 and configured to pass through corresponding apertures in both rails 204 and corner components 202.

Each rail 204 is configured to be inserted into corresponding corner components at predetermined depths which correspond to a selected length or width of door frame 200 (e.g., as measured along an axis parallel to the respective rail). In some examples, rails 204 are pre-made to a specified length corresponding to a single door frame dimension. In some examples, rails 204 are configured to be received by corner components 202 at a plurality of selectable depths corresponding to a plurality of length options. For example, fasteners 208 may positively engage rails 202 at multiple unique locations, such that rails 204 may be inserted and fastened multiple unique depths in corner components 202.

As shown in FIGS. 2-5, door frame 200 may include one or more vented rails 210 (see FIG. 9). Vented rails 210 have apertures 212 configured to allow air to pass through the rails. Vented rails 210 are configured to be received by corner components 202 at interface 214. Interface 214 is configured to have a cross-sectional contour matching that of vented rails 210. In some examples, vented rails 210 and rails 204 have differing cross sections. Vented rails 210 may positively engage interface 214, for example through a friction fit. In some examples, fasteners (e.g., fasteners 208) couple vented rails 210 and corner components 202. In some examples, vented rails 210 are non-releasably coupled to corner components 202, for example using an adhesive, welding, or soldering.

Vented rails 210 allow air to pass into a space between door panels (see associated description below), thereby cooling the door panels and the door overall. Accordingly, vented rails 210 may be utilized in an end of door frame 200 adjacent an exhaust of an air-cooling system and likewise in an end opposite the exhaust of the air-cooling system. For example, vented rails 210 may be located only at the top and bottom of door frame 200. In some examples, door frame has only rails 204 and no vented rails 210, such as when door frame 200 is intended for use with a cooking appliance without an air-cooling system.

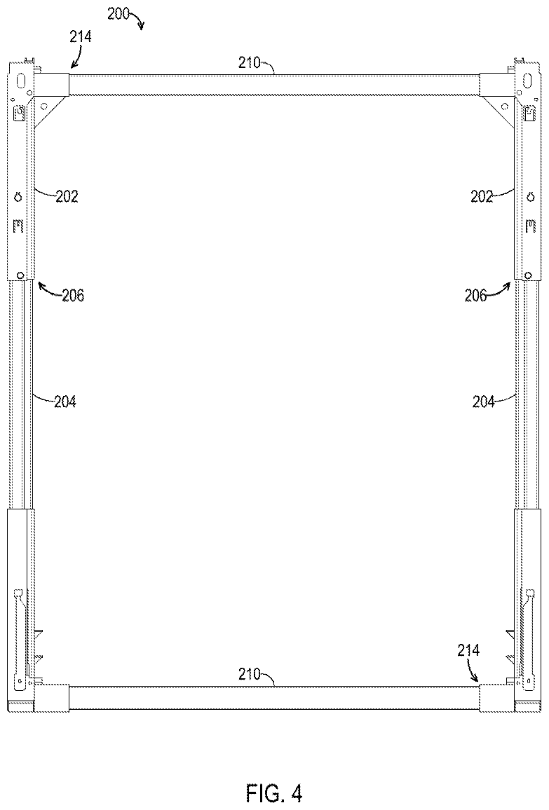

As depicted in FIG. 4, corner components 202 may comprise differently sized accommodating spaces for receiving rails 204 as compared to vented rails 210. In the example depicted in FIG. 4, the accommodating space associated with interface 206 (configured to receive rails 204) is larger (i.e., longer) than the accommodating space associated with interface 214 (configured to receive vented rails 210). For example, the larger accommodating space associated with interface 206 enables rails 204 to be inserted at different depths, while vented rails 210 are configured to be fixed in length and thus include only sufficient space to positively engage corner components 202.

As shown in FIGS. 2, 3, and 5, corner components 202 include a hinge receiver 216 configured to attach the door frame to a hinge mechanism. In some examples, every corner component utilized in door frame 200 includes hinge receiver 216. In some examples, only some corner components include hinge receiver 216 (e.g., only the corner components located at the bottom or on a single side of the assembled door frame). Hinge receiver 216 includes a receiving space for an internal hinge of the oven. For example, receiver 216 may have a narrow slot for coupling a blade hinge to the corner component. Additionally, or alternatively, hinge receiver 216 may comprise a mounting surface for the fastening of an external hinge. For example, hinge receiver 216 may have a mounting surface for an external spring-biased hinge, such as those commonly found in cooking appliances.

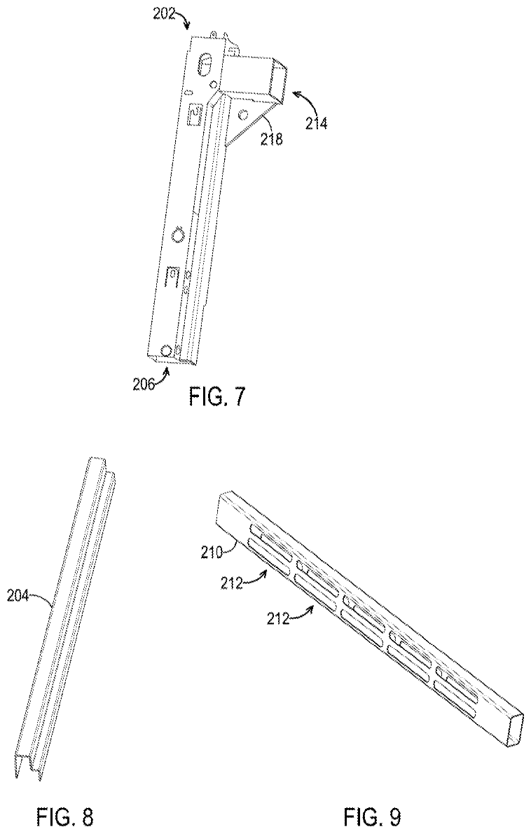

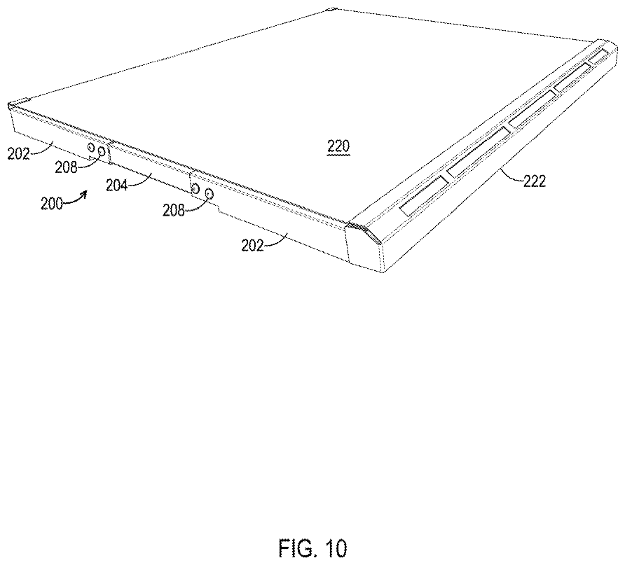

Turning now to FIG. 7, each corner component 202 includes a bracket 218 for mounting one or more door panels 220 (see FIG. 10) of the door. Each bracket 218 comprises a body having a generally planar surface for interfacing with the door panel. In some examples, bracket 218 includes a suitable coupling structure (e.g., an aperture for receiving a fastener) configured to enable the door panel to be mounted or installed on door frame 200. In some examples, panel 220 is coupled to bracket 218 with an adhesive, in which case any further coupling structure may be unnecessary. Door panels 220 may include a front door panel and a back door panel, such that when both are installed on frame 200, a space is formed therebetween.

In some examples, brackets 218 are configured such that when one or more door panels 220 are installed, an outer surface of the door panel lies substantially flush with an outer surface of frame 200. In other words, brackets 218 may define a plane parallel to the plane defined by the outer surface of the frame but offset by a distance substantially similar to the thickness of the door panel(s). In some examples, brackets 218 are configured to be flush with the outer surface of the door frame, such that when the door panel(s) is installed, an inner surface of the door panel lies substantially flush with the outer surface of frame 200.

Turning now to FIG. 10, one or more vent covers 222 may be disposed on frame 200 and configured to cover one or more vented rails 208. In some examples, vent cover 222 may be disposed only on the vented rail corresponding to an exhaust of the air from space between the panels. For example, in the case that the top of door frame 200 (when viewed from the front of the appliance) includes a vented rail in fluid communication with the air-cooling system, the bottom of door frame 200 may include a vented rail to release the air and therefore vent cover 222 may be disposed solely at the bottom of door frame 200.

### C. Illustrative Method of Assembly

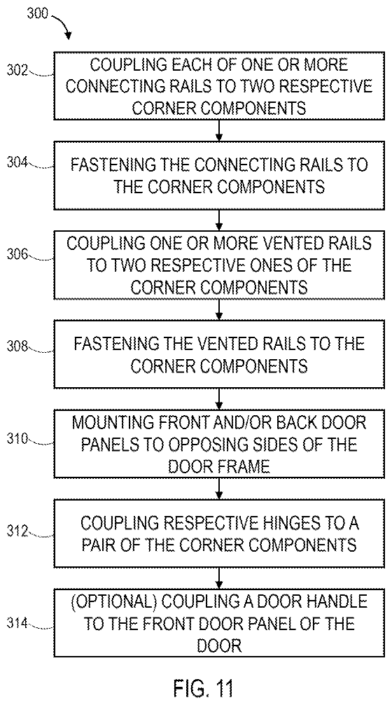

This section describes steps of an illustrative method 300 for manufacturing or assembling a door for use with a cooking appliance; see FIG. 11. Aspects of cooking appliance 100, door 106, and door frame 200, described above, may be utilized in the method steps described below. Where appropriate, reference may be made to components and systems that may be used in carrying out each step. These references are for illustration, and are not intended to limit the possible ways of carrying out any particular step of the method.

FIG. 11 is a flowchart illustrating steps performed in an illustrative method, and may not recite the complete process or all steps of the method. Although various steps of method 300 are described below and depicted in FIG. 11, the steps need not necessarily all be performed, and in some cases may be performed simultaneously or in a different order than the order shown.

Step 302 of method 300 includes coupling each of one or more connecting rails to two respective corner components. In some examples, coupling the rails may comprise inserting them to a specified depth in the corner components.

Step 304 of method 300 includes fastening the connecting rails to the corner components. In some examples, fastening the connecting rails may include the use of removable fasteners. In some examples, fastening the connecting rails may comprise the use of non-removable fasteners.

Step 306 of method 300 includes coupling one or more vented rails to two respective ones of the corner components. The number of vented rails and connecting rails adds up to four, such that the vented rail(s), connecting rail(s), and corner components form a door frame having a rectangular shape; wherein a corner component is at each vertex of the rectangle and either a connecting rail or a vented rail is at each edge of the rectangle. In some examples, coupling the vented rails may comprise inserting them to a specified depth in the corner components.

Step 308 of method 300 includes fastening the vented rails to the corner components. In some examples, fastening the vented rails may include the use of removable fasteners. In some examples, fastening the vented rails may include the use of non-removable fasteners.

Step 310 of method 300 includes mounting front and/or back door panels to opposing sides of the door frame. In some examples, mounting the front and back door panels includes the use of an adhesive. In some examples, the front door panel and/or the back door panel is configured to be mounted to brackets of the corner components.

Step 312 of method 300 includes coupling respective hinges to a pair of the corner components. In some examples, coupling the hinge to the corner component includes inserting a blade of the hinge into a corresponding slot or opening of the corner component (e.g., in the case of a knife hinge). In some examples, coupling the hinge to the corner component comprises fastening the hinge to a mounting surface of the corner component.

Optional step 314 of method 300 includes coupling a door handle to the front door panel of the door. In some examples, coupling the door handle to the front door panel comprises disposing an adhesive layer between a portion of the door handle and the front door panel. In some examples, coupling the door handle to the front door panel includes fastening the handle to the panel with a fastener such as a screw or bolt.

### D. Illustrative Combinations and Additional Examples

This section describes additional aspects and features of a door having a universal door frame for use with cooking appliances, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A door for use with a cooking appliance, the door comprising: a door frame including four corner components, each corner component having an opening configured to receive an end portion of a respective side rail; four side rails, each side rail coupled to two of the four corner components, wherein at least one of the side rails is configured to be insertable to different depths within the openings of the respective corner components.

A1. The door of A0, wherein each of the corner components has a mounting bracket, the door further comprising a door panel coupled to the door frame at the mounting brackets.

A2. The door of A1, wherein the door panel comprises glass and is fastened to each of the mounting brackets by an adhesive.

A3. The door of any one of paragraphs A0 through A2, wherein at least two of the corner components each include a respective hinge receiver configured to mate with a hinge of an oven.

A4. The door of any one of paragraphs A0 through A3, wherein at least one of the side rails is configured to include venting apertures configured to allow air to flow therethrough.

A5. The door of any one of paragraphs A0 through A4, wherein each of the side rails is coupled to corresponding corner components using one or more reusable fasteners.

A6. The door of A5, wherein the one or more reusable fasteners comprise a screw passing through the side rail and the corner component.

A7. The door of A5, wherein the one or more fasteners comprise snap-together fasteners.

B0. A cooking appliance comprising: a housing defining an oven cavity therein; and a door configured to selectively close the oven cavity, the door comprising: a door frame including four corner components, each corner component having an opening configured to receive an end portion of a respective side rail; four side rails, each side rail coupled to two of the four corner components, wherein at least one of the side rails is configured to be insertable to different depths within the openings of the respective corner components.

B1. The cooking appliance of B0, wherein each of the corner components has a mounting bracket, the door further comprising a door panel coupled to the door frame at the mounting brackets.

B2. The cooking appliance of B1, wherein the door panel comprises glass and is fastened to each of the mounting brackets by an adhesive.

B3. The cooking appliance of any one of paragraphs B0 through B2, wherein at least two of the corner components are coupled by a hinge to the cooking appliance.

B4. The cooking appliance of any one of paragraphs B0 through B3, wherein at least one of the side rails is configured to include venting apertures configured to allow air to flow therethrough.

B5. The cooking appliance of any one of paragraphs B0 through B4, wherein each of the side rails is coupled to corresponding corner components using one or more reusable fasteners.

B6. The cooking appliance of B5, wherein the one or more reusable fasteners comprise a screw passing through the side rail and the corner component.

B7. The cooking appliance of B5, wherein the one or more fasteners comprise snap-together fasteners.

C0. A method of manufacturing a cooking appliance, the method comprising: coupling a first rail to a first and a second corner component using first telescoping connections; coupling a second rail to a third and a fourth corner component using second telescoping connections; adjusting an effective length of the combined first rail, first corner component, and second corner component by changing an insertion depth of one of the first telescoping connections; adjusting an effective length of the combined second rail, third corner component, and fourth corner component by changing an insertion depth of one of the second telescoping connections; and coupling a first vented rail to the first and third corner components, the first vented rail including at least one aperture configured to allow air to pass therethrough.

C1. The method of C0, further comprising: coupling a second vented rail to the second and fourth corner components, the second vented rail including at least one aperture configured to allow air to pass therethrough.

C2. The method of C0 or C1, further comprising coupling at least one door panel to brackets of the first and second rails.

C3. The method of any one of paragraphs C0 through C2, wherein the first telescoping connections include inserting end portions of the first rail into the first and second corner components.

C4. The method of any one of paragraphs C0 through C3, wherein the first telescoping connections include inserting end portions of the first and second corner components into respective ends of the first rail.

### Advantages, Features, and Benefits

The different embodiments and examples of the universal door frame described herein provide several advantages over known solutions for assembling doors for cooking appliances. For example, illustrative embodiments and examples described herein allow for the simple assembly of many doors each having a different length or width.

Additionally, and among other benefits, illustrative embodiments and examples described herein allow for the assembly of a door for a custom-built cooking appliance having custom dimensions.

Additionally, and among other benefits, illustrative embodiments and examples described herein allow a simple assembly process for producing doors for cooking appliances.

Additionally, and among other benefits, illustrative embodiments and examples described herein allow the assembly of a door frame without the use (or with reduced use) of tools or machinery, for example through the use of snap-together components and adhesives.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A door for use with a cooking appliance, the door comprising:
a door frame including four corner components, each corner component having an opening configured to receive an end portion of a respective side rail;
four side rails, each side rail coupled to two of the four corner components, wherein at least one of the side rails is configured to be insertable to different depths within the openings of the respective corner components.

2. The door of claim 1, wherein each of the corner components has a mounting bracket, the door further comprising a door panel coupled to the door frame at the mounting brackets.

3. The door of claim 2, wherein the door panel comprises glass and is fastened to each of the mounting brackets by an adhesive.

4. The door of claim 1, wherein at least two of the corner components each include a respective hinge receiver configured to mate with a hinge of an oven.

5. The door of claim 1, wherein at least one of the side rails is configured to include venting apertures configured to allow air to flow therethrough.

6. The door of claim 1, wherein each of the side rails is coupled to corresponding corner components using one or more reusable fasteners.

7. The door of claim 6, wherein the one or more reusable fasteners comprise a screw passing through the side rail and the corner component.

8. The door of claim 6, wherein the one or more fasteners comprise snap-together fasteners.

9. A cooking appliance comprising:
a housing defining an oven cavity therein; and
a door configured to selectively close the oven cavity, the door comprising:
a door frame including four corner components, each corner component having an opening configured to receive an end portion of a respective side rail;
four side rails, each side rail coupled to two of the four corner components, wherein at least one of the side rails is configured to be insertable to different depths within the openings of the respective corner components.

10. The cooking appliance of claim 9, wherein each of the corner components has a mounting bracket, the door further comprising a door panel coupled to the door frame at the mounting brackets.

11. The cooking appliance of claim 10, wherein the door panel comprises glass and is fastened to each of the mounting brackets by an adhesive.

12. The cooking appliance of claim 9, wherein at least two of the corner components are coupled by a hinge to the cooking appliance.

13. The cooking appliance of claim 9, wherein at least one of the side rails is configured to include venting apertures configured to allow air to flow therethrough.

14. The cooking appliance of claim 9, wherein each of the side rails is coupled to corresponding corner components using one or more reusable fasteners.

15. The cooking appliance of claim 14, wherein the one or more fasteners comprise snap-together fasteners.

16. A method of manufacturing a cooking appliance, the method comprising:
coupling a first rail to a first and a second corner component using first telescoping connections;
coupling a second rail to a third and a fourth corner component using second telescoping connections;
adjusting an effective length of the combined first rail, first corner component, and second corner component by changing an insertion depth of one of the first telescoping connections;
adjusting an effective length of the combined second rail, third corner component, and fourth corner component by changing an insertion depth of one of the second telescoping connections; and
coupling a first vented rail to the first and third corner components, the first vented rail including at least one aperture configured to allow air to pass therethrough.

17. The method of claim 16, further comprising:
coupling a second vented rail to the second and fourth corner components, the second vented rail including at least one aperture configured to allow air to pass therethrough.

18. The method of claim 16, further comprising coupling at least one door panel to brackets of the first and second rails.

19. The method of claim 16, wherein the first telescoping connections include inserting end portions of the first rail into the first and second corner components.

20. The method of claim 16, wherein the first telescoping connections include inserting end portions of the first and second corner components into respective ends of the first rail.
